(19) United States
(12) Patent Application Publication
(10) Pub. No.: US 2008/0071585 A1
(43) Pub. Date: Mar. 20, 2008

(54) Method of providing insurance coverage as a security deposit guarantee

(75) Inventor: Joseph McNasby, Steamboat Springs, CO (US)

Correspondence Address: DAY PITNEY LLP, 7 TIMES SQUARE, NEW YORK, NY, 10036-7311, US

(73) Assignee: MDM GROUP ASSOCIATES, INC.

(21) Appl. No.: 11/985,029

(22) Filed: Nov. 12, 2007

Related U.S. Application Data
(63) Continuation-in-part of application No. 10/673,798, filed on Sep. 29, 2003.

(51) Int. Cl. G06Q 40/00; G06Q 20/00

(52) U.S. Cl. 705/4; 705/39

(57) ABSTRACT

A method of administering property insurance coverage for protecting individuals from liability which may arise as the result of excess wear and tear and/or damage which may occur to a leased residential unit during the lease term includes relieving tenants of providing up-front security deposits and providing property managers with a service product which will generate fees for the property manager as well as provide guarantees to lessors making use of the service product.

This application is a continuation-in-part of application Ser. No. 10/673,798, filed on Sep. 29, 2003.

### BACKGROUND OF THE INVENTION

1. Field of the Invention

The present invention relates to a method of administering property and liability insurance coverage for a leased, (i.e. rented) residential premise in lieu of requiring a lessee (i.e., a tenant) to provide a security deposit. This insurance strategy results in relieving a lessee from having to post a security deposit payment and from being liable for accidental damage to the leased premises up to a pre-set limit while still protecting a lessor (i.e., the landlord) against physical damage loss events.

2. Description of the Prior Art

In creating the lease relationship and lease agreement, the lessor will typically require a security deposit from the prospective tenant. The term “security deposit” means the pledge of property, money, or some additional obligation of a tenant to secure an obligation. The security deposit functions to offset any outstanding debt associated with the lessee. Security deposits mitigate risks associated with non-payment and lease non-compliance, and function to ensure the safe return of the property at the end of an agreement term. For example, leased premises must be maintained and delivered back to the lessor in relatively good condition. In this regard, security deposits ensure that lessees are held financially responsible for any wear and tear which is in excess of normal wear and tear, including post-warranty repairs. Lessors require cash-based security deposit payments to be made prior to the transfer of property or other similar rights.

In many instances, however, security deposit payments can present a source of disagreement and/or sizeable barriers to entry for many consumers. Disagreements over damage or the amount of damage are the source of numerous problems for lessees, property managers and lessors. In addition, every year, millions of people are unable to move into residential units because they are unable to make security deposit payments to lessors. It is often difficult and inconvenient for a lessee to advance funds in a lump sum manner for security deposits upon execution of the lease agreement. For example, a person may meet every lessor screening test in regard to the rental of a residential unit, but not be allowed to execute a lease agreement with the lessor because the person cannot make a substantial security deposit. Moreover, lessors may also find themselves with substantial liability upon termination of their lease relationship with the lessor. Oftentimes, the ultimate responsibility for the care and well-being of the leased premises is placed upon the property manager. Therefore, when the damage to the property exceeds the amount provided as a security deposit, the property manage is often forced to pay the excess damage costs out of their own income. This can lead to a financial hardship and an unexpected financial burden to property managers.

In addition, the legalities associated with the maintenance of a security deposit throughout the duration of the lease agreement can be onerous. Generally, states hold lessors to strict guidelines as to when and how to return security deposits. Lessors are typically required to place the deposits in a separate account, paying tenants any accrued interest on the deposits within 30 days after the termination of the tenancy. The rules vary from state to state, but lessors usually have a set amount of time in which to return deposits, usually 14 to 30 days after the lessee vacates the premises, either voluntarily or by eviction. Lessors may normally make certain deductions from a tenant's security deposit, provided they do it correctly and for an allowable reason. Many states require lessors to provide a written itemized accounting of deductions for unpaid rent and for repairs for damages that go beyond normal wear and tear, together with payment for any deposit balance. Lessors who violate these laws can be held to stiff penalties.

In the prior art, methods of guaranteeing a security deposit have been attempted to release lessees from the burden of having to provide cash-based security deposits while assuring lessors of protection against financial loss. For example, U.S. Pat. No. 6,208,978 entitled “System and Method for Issuing Security Deposit Guarantees Based on Credit Card Accounts” issued on Mar. 27, 2001 to Walker et al. discloses a data processing system coupled to a data storage system that enables consumers to obtain security deposit guarantees from their credit card issuers in accordance with private agreements such as a lease agreement in lieu of providing a cash-based security deposit to the lessor at the inception of the lease agreement. This guarantee cover issued by the lessee cardholder's credit card issuing bank or credit card issuer functions to provide the lessor with an adequate assurance of security and lease agreement compliance in the event that the cardholder does not fulfill his tenant obligations as defined in the agreement. In the event that a lessor makes a claim to the credit card issuer system within thirty days after the end of the lease term, the amount of the claim is charged to the lessee's credit card, thereby causing the credit card issuer system to make a payment to the lessor. Many of these methods have not been satisfactory over the long term, due to insufficient credit limits, high interest rates, a potential for a debt trap, and other risks.

While many insurance products and services exist to limit one's liability and/or to provide monetary protection upon the occurrence of certain events, no corresponding insurance coverage exists which functions as a guarantee to lessors instead of providing a security deposit. In a similar manner, no insurance coverage exists which can be administered by an entity to the lease transaction, namely the property manager, thereby providing the property manager with control over claim adjudication regarding a leased premises directly under his management, as well as entitling him to an additional source of revenue through an administrative fee. Furthermore, no insurance mechanism exists which effectively transfers the risks associated with covering accidental damage from a tenant to a property manager or an insurer.

Accordingly, there exists a need for a method which overcomes the shortcomings of the prior art and allows lessees to enter into a lease arrangement without requiring a security deposit. Without such a method, many potential lessees will continue to be prevented from acquiring access to properties that require security deposits. To be effective, such a method must enable consumers to utilize the insurance premium payments as a substitute for the often sizeable lump sum security deposit collected at lease signing and at the same time assure lessors that the lessee has a stake in the maintenance of the leased apartment, thereby providing lessors with protection against financial loss.

### OBJECTS AND SUMMARY OF THE INVENTION

It is therefore an object of the present invention to provide a method for providing insurance policies, products, services, and/or coverage for leased premises for providing insurance protection against liability which may arise as the result of excess wear and tear and/or damage which may occur to a leased residential unit during the lease term.

It is therefore a further object of the present invention to provide a method for providing insurance policies, products, services and/or coverage for leased premises for providing insurance protection against liability which may arise as the result of post-warranty repairs.

It is therefore a further object of the present invention to provide a method for providing insurance policies, products, services and/or coverage for residential units.

It is therefore a still further object of the present invention to provide a method for providing insurance policies, products, services and/or coverage which effectively transfers the risks associated with covering accidental damage from a tenant to a property manager or an insurer.

It is therefore a final object of the present invention to provide a method that enables property managers to utilize an insurance policy to obtain a security deposit guarantee from lessees in accordance with lease agreements that is accepted by lessors in lieu of cash-based security deposit payments that typically have been required prior to the transfer of property.

These and other objects can be attained by creating a novel, insured, self-administered method in which the property manager is solely responsible for adjudicating and administering claims. This method allows a tenant to transfer risk to a property manager, thereby causing the property manager to assume responsibility for all incurred accidental damage. In the present method, the property manager can be responsible for managing the insurance policy. In this regard, the tenant is required to pay a flat fee up front each month or up front, depending upon the term of the lease, to be used by the property manager to establish a loss fund from which the property manager effects payment for damages sustained to the property. For his convenience, the tenant pays this predetermined monetary amount, or gross premium, instead of providing the lessor with a large sum in advance of taking possession of the premises. The insurer only plays an active role in the insurance scheme when it is contacted to assume coverage for benefit payments exceeding a certain percentage of the gross premium in a particular policy period. Because of the insurance laws in some states, a fully insured group policy may be issued in the name of the property manager. In these cases the insurer provides benefits to the tenant and participates in the administration of the program. The property manager continues to participate in the administration of the program. In these situations, the property manage continues to adjudicate and administer claims while the claims funds are held by the insurer.

For the tenant, this method of insurance has the advantage of increasing available cash because instead of paying a lump sum at the inception of the lease agreement, an affordable insurance charge is paid as agreed. Also, with the flat fee program, the tenant receives protection up to a certain benefit amount for eligible losses to the unit and the contents of a leased unit. In addition, data and information related to the tenants, including use habits and leasing histories do not have to be communicated to the underwriter. Rather, the underwriter evaluates the property manager. For property managers, this method of insurance coverage presents the advantage of protecting them from having to pay for damage to the leased units out of their own pocket. Moreover, due to the self-administered nature of the program, property managers are entitled to an extra source of income through the administrative fees and the retention of any leftover funds in the loss account. Furthermore, the lessor is confident that his interest in the premises is fully protected. The lessor is provided with assurances that the tenant will abide with the terms of an appropriate lease agreement because a fund will be created from which the lessor is guaranteed to obtain payment for damages caused by the tenant during his occupancy of the leased property.

Accordingly, the present invention provides a method of administering property insurance coverage for protecting individuals from liability which may arise as the result of excess wear and tear and/or damage which may occur to a leased residence during the lease term, and further, for protecting individuals from liability for post warranty repairs. More specifically, it is an object of the present invention to provide a method that enables a property manager to utilize an insurance policy to obtain a security deposit guarantee in accordance with a lease agreement in lieu of a cash-based security deposit payment that traditionally has been required prior to the transfer of property.

In such a case, the property manager registers a particular leased residential unit for the flat fee program by completing an application form created by the insurer. The property manager has the option of offering the program to a tenant on either a voluntary or a mandatory basis. The voluntary plan permits the tenant to choose whether to purchase the program for a specified monetary amount. On the other hand, the mandatory plan is provided to the tenant as a service at no additional cost to the tenant. In either option, the flat fee program outlined in the present invention could be subject to other applicable housing laws. The insurer then negotiates and structures the insurance coverage with the underwriter. After reviewing the lease agreement and depending on a set of other parameters (such as the risks associated with the particular leased premises), the underwriter will provide a premium quotation for the insurance coverage to the property manager. The property manager incorporates the gross premium charge determined by the underwriter into the lease agreement. The gross premium is divided by the property manager into three parts. First, a fiduciary account is established as a loss fund whose proceeds in turn are used to satisfy any current and future debts of the tenant. Additionally, the property manager charges the tenant an up front, monthly or periodic administrative fee to maintain the guarantee. Lastly, a portion of the gross premium is paid to the underwriter as a net premium charge. In some states, the fiduciary account may be held by the insurer.

Thereafter, the property manager is responsible for managing a claim for damage and payment for the losses associated therewith. The tenant reports an incident directly to the property manager who is in charge of the claim process. The property manager assesses the property damage and determines whether it warrants insurance coverage. If the damage is covered under the insurance policy, the property manager remits benefit payment from the loss fund. Additionally, pursuant to the insurance policy, the insurer provides the property manager with a guarantee that it will indemnify the property manager if the total covered claims that occur in a specified policy period exceed a certain percentage of the gross premium generated in that policy period. This coverage guarantee, referred to as stop loss coverage, will remain in effect during the term defined in the lease agreement. Stop loss coverage is only triggered if the property manager has exhausted both the loss fund and his earned administrative fees. Lastly, the property manager provides the underwriter with monthly management reports detailing the premium and damages paid out of the loss fund. In those states requiring the group policy and insurer participation, the property manager submits a monthly report of claims paid by the property manager for reimbursement by the insurer. In these states, the property manager can participate in any profits. They can not be responsible for more than the premiums paid to the insurer.

### BRIEF DESCRIPTION OF THE DRAWINGS

The following detailed description, given by way of example and not intended to limit the present invention solely thereto, will be best understood in conjunction with the accompanying drawing figures, in which:

FIG. 1 is a detailed schematic flowchart illustrating a method for generating and issuing an insurance policy in accordance with the present invention;

FIG. 2 is a detailed schematic flowchart illustrating a method for creating and managing a lease agreement in accordance with the present invention; and

FIG. 3 is a detailed schematic flowchart illustrating a method for administering property and liability insurance coverage in accordance with the present invention.

### DETAILED DESCRIPTION OF THE PREFERRED EMBODIMENT

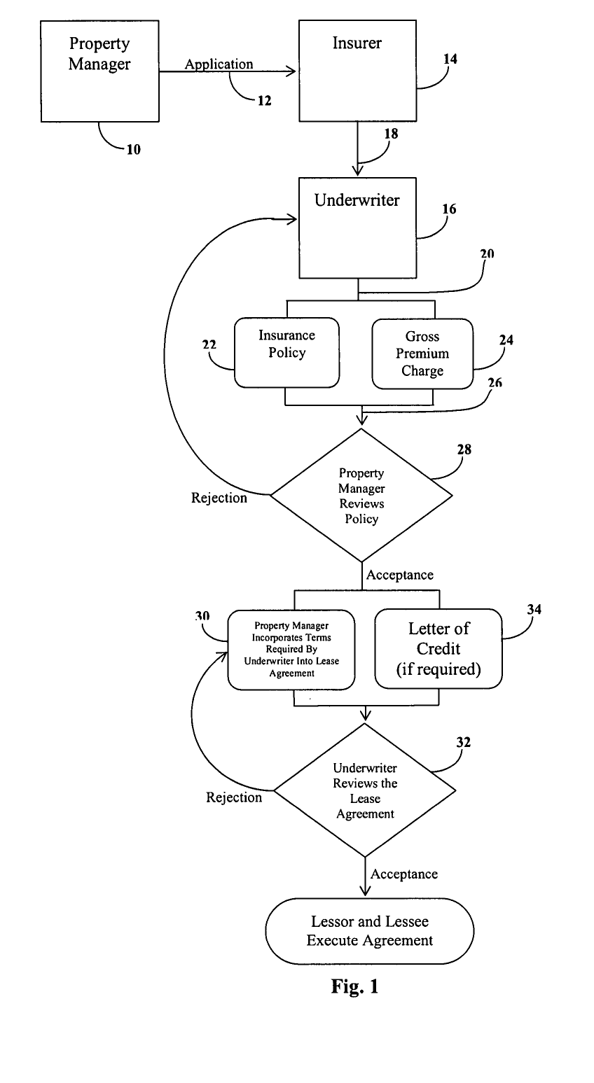

Referring now to the drawings in greater detail in which like numerals indicate like elements throughout the several views, FIG. 1 depicts therein a flowchart illustrating a method for generating and issuing an insurance policy in accordance with the present invention. Referring to FIG. 1, the present invention begins with a property manager 10 preparing and submitting a completed application form 12 to an insurer 14. The step of completing and forwarding the application form 12 to the insurer enables the property manager to register a particular leased apartment for the flat fee program, thereby putting the program into motion. An underwriter 16 is then engaged to facilitate the provision of insurance between the property manager and the insurer. The insurer submits to the underwriter data and/or information 18 which is relevant to determining insurance policies and premiums for residential units.

Data and/or information 18 related to the lease of residential units includes type and age of premises, parts and/or components and/or systems of the premises along with their repair costs, replacement costs, probability of damage, probability of post-warranty repairs necessitated by wear and tear, damage, malfunctioning components and/or systems and defects in materials, parts, components, systems and/or workmanship, average costs for repairs, historical leasing data, including typical repair costs and average total excess wear and tear costs for the entire premises. Premises leasing data and/or information also includes locality, regional and geographical data which is correlated with excess wear and tear along with data and/or information which is related to use habits and/or patterns in a given area or areas.

At step 20, the underwriter will formulate an insurance policy 22 and corresponding appropriate gross premium charge 24. This insurance policy protects a tenant from damage to the unit which results from theft or an accident within the unit. The policy does not cover gross negligence or willful and wanton conduct. At step 26, the policy can then be presented to the property manager for acceptance. The property manager may then, at step 28, accept or reject the insurance policy. Although the property manager obtains the insurance policy on behalf of the lessee, the lessee typically does not execute the policy. Rather, the tenant typically only receives a certificate of coverage in paper form confirming coverage and informing him of the nature and extent of the insurance protection. The property manager is the actual policyholder. Upon acceptance of the insurance policy, the property manager incorporates the terms required by the underwriter into a lease agreement 30 drafted by a lessor. The lease agreement is then reviewed 32 by the underwriter for compliance with his terms. If the underwriter approves of the lease agreement, the lessor and lessee execute the agreement. When the lessee executes the agreement, risk has been effectively transferred from the tenant to the property manager or insurer. The lessee will have no liability for accidental damage to the property up to a set limit. In addition, the property manager may be required to supply a Letter of Credit (LOC) 34, promising to provide the underwriter with a predetermined amount that is calculated to be sufficient to cover the identification of damage to the premises and costs associated with repair and replacement in the event that the damage to the premises in a particular policy period exceeds a certain percentage of the gross premium charge, thereby invoking the underwriter's guarantee to indemnify the property manager. A letter of credit is not required where the insurer holds the claims fund.

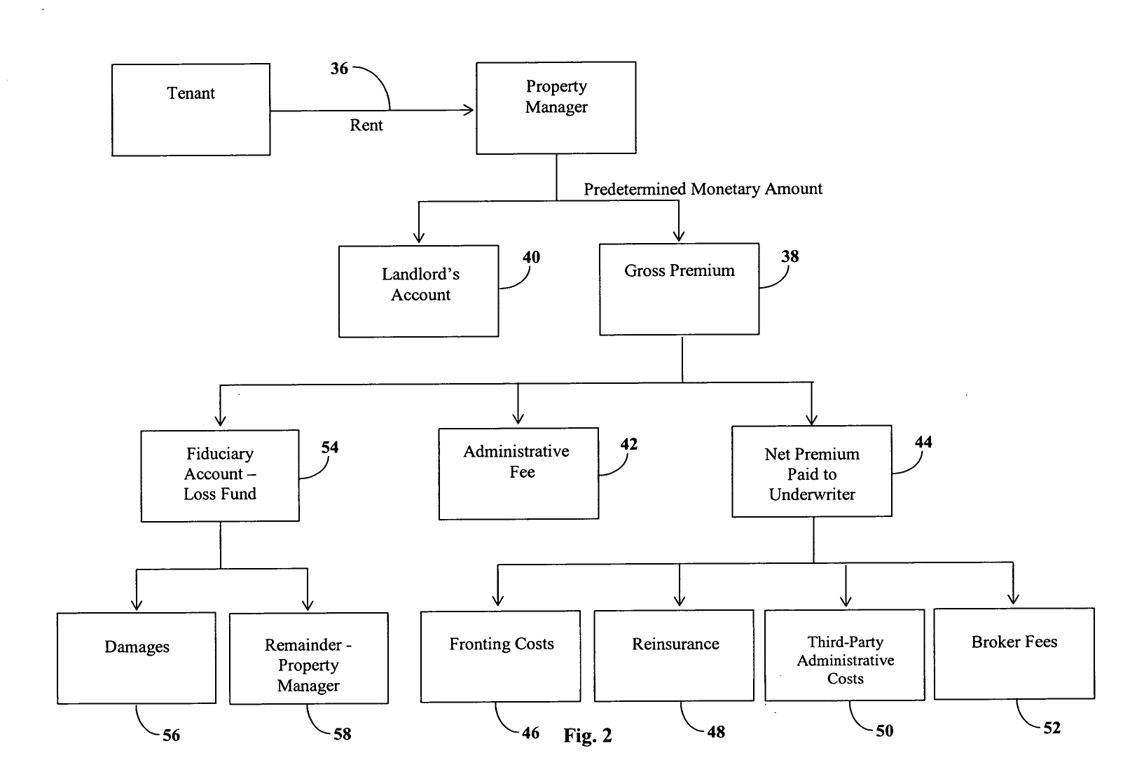

FIG. 2 is a flow diagram that illustrates the process for creating and managing a lease agreement in accordance with the method of the present invention. Referring to FIG. 2, a lease payment 36 is received by the property manager. The property manager then extracts the gross premium 38 from the lease payment and preferably deposits the remainder directly into a bank account of the lessor 40. The property manager is entitled to a guaranteed flat fee of the total gross premium as an administrative fee 42. A predetermined net premium 44 is paid to the underwriter for fronting costs 46, insurance and reinsurance charges 48, third-party administrative costs 50, and broker fees 52. The remaining funds are placed into a fiduciary account as a loss fund 54 administered by the property manager. The fiduciary account constituting the loss fund financed by the gross premium is established to satisfy debts for damages 56 incurred on a continuing basis. In some states, the loss fund is held by the insurer.

At the end of the year, the property manager preferably retains the remainder 58 in the loss fund. Three months after the policy period has ended, thirty percent of the amount remaining in the loss fund for that particular policy term is available for use by the property manager. The balance will be divided into two equal installments at six months and nine months after the specified policy term has ended. During this time, additional funds should typically already be available to pay claims for the new policy period due to additional sales that have taken place within the initial ninety day waiting period. If the property manager decides not to renew the insurance policy or the policy is canceled, seventy percent of the available loss fund money must remain untouched for twelve months after the termination date of the program. This is to ensure that adequate monies exist in the loss fund to cover any damage sustained by the premises for at least the remainder of the lease term, which is typically one year. Because the end of a policy period may not always coincide with the end of a lease agreement, the property manager is not permitted to deplete all of the remaining funds in the loss account until the lessor's right to indemnity from the lessee for damage to the premises has expired.

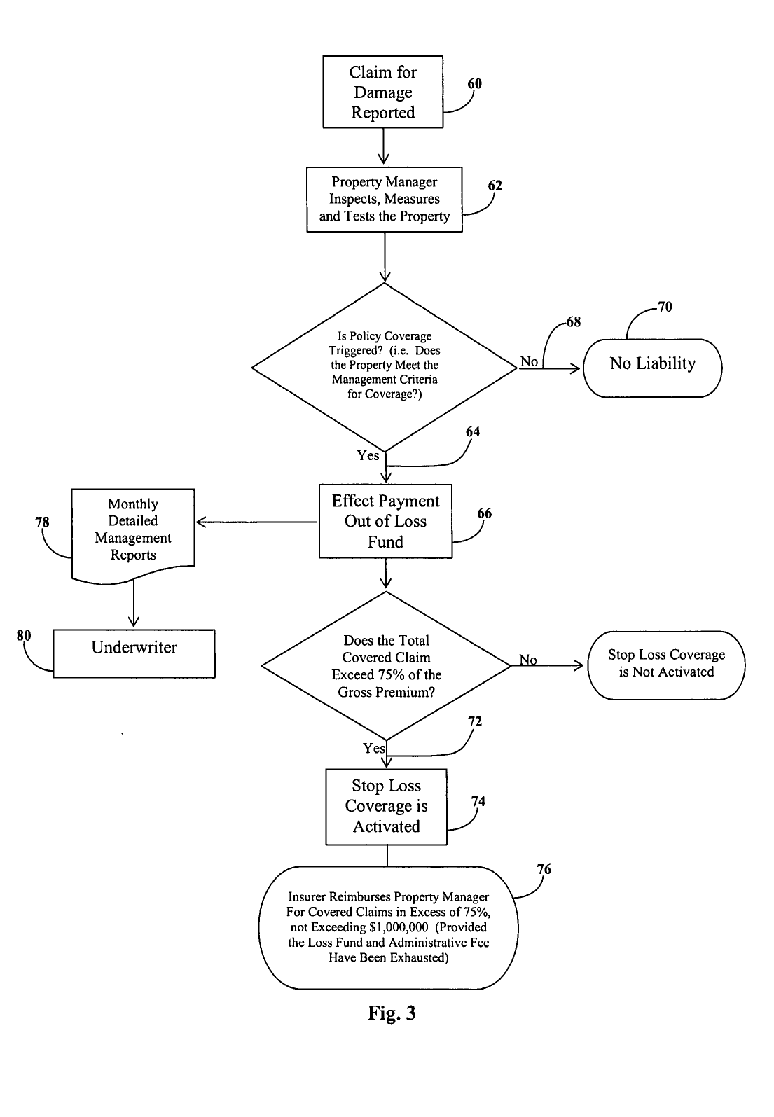

FIG. 3 is a flow diagram that illustrates the process for self-administering property and liability insurance coverage in accordance with the method of the present invention. When a claim for damage 60 is reported, the property manager is responsible for inspecting, measuring, and testing the property 62 in order to determine whether the property meets the management criteria for coverage. If the policy coverage is triggered 64, the property manager will assume responsibility for the damage, and effect payment 66 for the excess wear and tear and/or damage out of the loss fund, in accordance with the terms of the insurance policy. If, however, coverage is not triggered at step 68, the property manager will have no liability at step 70. If the total covered claims that occur in a specified policy period exceed a certain percentage of the gross premium generated in that policy period 72, stop loss coverage is activated 74. Stop loss coverage is provided so that the property manager has protection against large or catastrophic losses. If this occurs, the insurer will reimburse 76 the property manager for covered claims in excess of 75%, not exceeding $1,000,000, in a policy period. Stop loss coverage is only triggered if the property manager has exhausted both the loss fund and his earned administrative fees. In those states where the group policy is used, the property manager is not responsible for more than the premium paid to the insurer. The property manager receives the balance of the loss or claims fund held by the insurer after all claims are paid.

In addition, the property manager is responsible for compiling monthly detailed management reports 78 for the benefit of the insurance underwriter 80. These reports include complete informational indicia on the insured portfolio such as the physical address of the property, amount of covered damages paid out of the loss fund, and premium amount. Upon expiration of the term of the lease agreement, the tenant may request a new lease agreement. If the new lease agreement is requested, a new insurance application is received. If a new lease agreement is not requested, the program terminates.

Those of ordinary skill in the art will recognize that the present invention makes advances in the area of lease management. The present invention provides a method of administering property insurance coverage for protecting individuals from liability which may arise as the result of excess wear and tear and/or damage which may occur to a residential unit during the lease term, and further, for protecting individuals from liability for post warranty repairs. The method dispenses with the traditional security deposit mechanism, which frequently creates an extreme financial burden on a lessee, and replaces it with an insured mechanism in which the lessor is still assured of coverage for any incurred property damage. Throughout the lease, maintenance of the leased apartment through the administration of insurance coverage is the responsibility of the property manager. The insurer functions to provide an insurance guarantee to cover benefits for claims which exceed a certain percentage of the gross premium in a particular policy period.

Thus, having fully described the present invention by way of example with reference to the attached drawing figures, it will be readily appreciated that many changes and modifications may be made to the invention without departing from the spirit or scope of the invention which is defined in the appended claims.

What is claimed is:

1. A method of providing insurance coverage as a security deposit guarantee, comprising the steps of:
establishing a contractual agreement between a property manager on behalf of a lessee to insure a leased residential unit and said insurer ready to insure against losses caused by a lessee up to a predetermined limit; and
providing a policy of indemnity insurance sufficient to compensate for said possible losses.

2. The method of claim 1, wherein said property manager submits an application form to an insurer regarding said leased residential unit.

3. The method of claim 1 wherein the property manager assumes the exposure as part of a self-insured program.

4. The method of claim 3 wherein the property manager determines the amount to be collected from the lessee.

5. The method of claim 1, wherein said application form is created by said insurer.

6. The method of claim 1, wherein said submitting step is carried out by said property manager.

7. The method of claim 1, wherein said insurer evaluates whether to agree to the transfer of a proposed risk using an insurance underwriter.

8. The method of claim 1, wherein said insurer communicates information regarding said proposed risk to said insurance underwriter.

9. The method of claim 1, wherein said property manager receives a binding commitment from said insurer regarding the acceptance of said proposed risk.

10. The method of claim 1, wherein said insurance underwriter determines a quote of a particular monetary amount forming the basis of said gross premium charge to be collected and managed by said property manager.

11. The method of claim 1, wherein said property manager supplies a letter of credit (LOC) to said insurance underwriter in an amount specified by said insurance underwriter.

12. The method of claim 1, wherein said proposed risk relates to said leased residential unit.

13. The method of claim 1, wherein said insurer assures payment to said property manager, if said losses occur.

14. A method of providing insurance coverage as a security deposit guarantee, comprising the steps of:
executing an agreement for a leased residential unit by a lessor and lessee directing payment of lease payments to a property manager;
collecting said lease payments from said lessee according to said agreement; and
removing a gross premium charge from said lease payments.

15. The method of claim 14 wherein the property manager assumes the exposure as part of a self-insured program.

16. The method of claim 14 wherein the property manager determines the amount to be collected from the lessee.

17. The method of claim 14, wherein said agreement incorporates terms required by an insurance underwriter.

18. The method of claim 14, wherein said insurance underwriter reviews and approves said agreement.

19. The method of claim 14, wherein said collecting and removing steps are performed by said property manager.

20. The method of claim 14, wherein said property manager deposits said lease payments received into an account held by said lessor.

21. The method of claim 14, wherein said property manager deposits said lease payments into an account held by said insurer.

22. The method of claim 14, wherein the duration of said agreement is one year.

23. The method of claim 14, wherein the directing step is performed on a monthly basis.

24. The method of claim 14, wherein proceeds from said gross premium charge are distributed according to:
a guaranteed flat fee of the total revenue collected is retained by said property manager;
a portion is placed into a fund administered by said property manager; and
a net premium is paid to said insurance underwriter.

25. The method of claim 24, wherein said insurer assures payment for losses which exceed a certain percentage of said gross premium charge when said property manager has exhausted both said fund and said guaranteed flat fee.
